(19) United States
(12) Patent Application Publication
(10) Pub. No.: US 2022/0380599 A1
(43) Pub. Date: Dec. 1, 2022

(54) TRANSPARENT POLYMERIC MATERIALS WITH HIGH OXYGEN DIFFUSION CONTAINING DI-FUNCTIONAL POSS CAGES WITH HYDROPHILIC SUBSTITUENTS

(71) Applicant: Acuity Polymers, Inc., Rochester, NY (US)

(72) Inventors: Wayne Ferrar, Fairport, NY (US); James A. Bonafini, JR., Kendall, NY (US)

(21) Appl. No.: 17/736,553

(22) Filed: May 4, 2022

Related U.S. Application Data
(60) Provisional application No. 63/183,901, filed on May 4, 2021.

(51) Int. Cl. C08L 83/10; G02B 1/04

(52) U.S. Cl. CPC C08L 83/10; G02B 1/043; C08L 2201/10; C08L 2203/02

(57) ABSTRACT

A new class of silicone monomers, providing transparent materials and imparting hydrophilic properties have been developed. These materials are incorporated into ophthalmic devices such as soft and rigid gas permeable (RGP) contact lenses. These new silicone monomers include Polyhedral Oligomeric Silsesquioxane (POSS) with two polymerizable groups and six organofunctional groups. These types of structures incorporate at least two available sites for polymerization allowing for the incorporation of the silsesquioxane cage into the backbone of a macromolecule. Additional functional sites allow the design of specific chemical features which address needed material properties.

### TECHNICAL FIELD

The present invention relates to ultra-high gas permeable (Dk) materials and methods of producing the same; and more particularly to high Dk materials having Dk values greater than 100; and still more particularly to high Dk suitable for use as rigid gas permeable contact lenses. Hydrogels were also prepared.

### BACKGROUND OF THE INVENTION

Contact lens materials are transparent materials made from organic polymers that are highly crosslinked. Two types of lenses are available—either soft or hard. Soft lenses are categorized as silicone hydrogels made from combining soft silicone polymers with hydrophilic polar materials. This combination of properties makes the silicone hydrogels the preferred lens for comfort on the patient's eye. Unfortunately, silicone hydrogel lenses have low oxygen permeability which can cause damage to the eye over a long period.

On the other hand, hard lenses offer greater oxygen permeability but are seen as less comfortable then soft lenses. Hard lenses are generally hydrophobic and may need surface modification to allow good wetting in the eye which improves patient comfort. Wetting in hard lenses, or rigid gas permeable (RGP) lenses, is achieved by adding acids that re-arrange to the surface of the lens. As the name implies, RGP lenses have increased oxygen permeability over soft lenses and traditional hard lenses. This property that allows oxygen transport through the material is an important advantage for the health of the eye.

Polyhedral Oligomeric Silsesquioxane (POSS) monomers have been incorporated into ophthalmic materials. By way of example, U.S. Pat. No. 6,586,548 ('548 patent) teaches the polymerization of vinyl monomer for biocompatible materials, where one of the components is a POSS monomer (also referred to as POSS cages). The POSS cages of the '548 patent have a single ethylenically unsaturated radical to serve as the polymerizable functional group. These materials can be transparent and suitable for contact lenses. However, the oxygen permeability of these materials is low, with Dk values 17-34.

U.S. Pat. No. 7,198,639 ('639 patent) uses hydrosilation by reaction of silicon-hydrides with vinyl groups and a platinum catalyst to incorporate POSS cages into soft lenses. Alternatively, free radical polymerization is used to incorporate POSS cage acrylic and/or styrenic groups. POSS molecules functionalized with alcohol, amine, thiol, epoxy and isocyanate groups were also useful in the '639 patent. The POSS molecules are multifunctional, with three functional groups emanating from the vertices of open cages. These polymeric compositions can be made into intraocular lens (IOL) implants, corneal inlays, and other related objects. However, the oxygen transport properties of these materials were not reported, as these materials were intended for implantation into the eye as IOL implant and corneal inlays.

U.S. Pat. No. 10,633,472 describes a method for preparing materials with high oxygen transport (high Dk). The monomers include fluoroacrylates, a hydroxyalkyl tris(trimethylsiloxy)silane, a hydroxyalkyl terminated polydimethylsiloxane, and styrylethyltris(trimethlysiloxy)silane (styryl tris). It is also necessary to include a crosslinking agent such as alkylglycol dimethacrylate, and a hydrophilic agent such as methacrylic acid. Dk values greater than 175 were reported. The materials were fashioned with a lathe into rigid gas permeable (RGP) contact lenses.

In a further example, POSS methacrylate was incorporated into a poly(urethane) in WO 2016/115507. The cured compositions of the polymeric compositions were suited for intraocular lenses and contact lenses. The urethane-based acrylate copolymers were also applicable to other corneal prosthetics.

### SUMMARY OF THE INVENTION

In accordance with an aspect of the present invention, a new class of silicone monomers has been developed that can be incorporated into ophthalmic devices to give transparent materials that impart hydrophilic properties into RGP lenses. These new silicone monomers are Polyhedral Oligomeric Silsesquioxane (POSS) with two polymerizable groups and six organofunctional groups. These monomers with two available sites for polymerization allow for the incorporation of the silsesquioxane cage into the backbone of a macromolecule. In this way, the architecture of the resulting polymer is different than POSS monomers that have a single polymerizable group, where the resulting silicone cage is pendant to the polymer backbone. Additionally, POSS monomers with more than two polymerizable groups form gel like structures and can be used for surface modification of fillers. By incorporating the POSS cage into the polymer backbone, the structure of the resulting polymer can have linked silicone cages in a linear array or incorporate other polymerizable monomers to form linear copolymers.

This type of unique polymer architecture allows for the incorporation of other desirable properties through the remaining six functional moieties. It has been found that incorporation of PEG functional groups on at least some of the available vertices of the POSS cage imparts a hydrophilic character that extends throughout the material network. Furthermore, it has been discovered that replacing some of the poly(ethylene glycol) (PEG) moieties with other functional groups results in compatibilization of the functional POSS monomers with other organic monomers to preserve the transparent properties necessary for a lens.

### DETAILED DESCRIPTION

Rigid gas-permeable monoliths are cut into lens shapes to improve visual acuity in people with astigmatisms. Early lenses were made from poly(methyl methacrylate). Many generations of fluoroacrylates and siloxanes have led to improve oxygen permeability and wettability. This has resulted in both greater comfort to the patient and improved health within the eye.

Incorporation of fluoroacrylates into the lens increases the mechanical properties by making the lens stiffer. At the same time, the oxygen permeability of these materials is higher than those that do not incorporate these monomers. One exemplary fluoroacrylate monomer is hexafluoro-i-propylmethacrylate (HFiPMA).

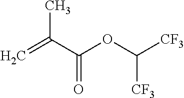

The siloxanes used in contact lens synthesis are generally linear and branched siloxanes. Linear siloxanes include silicone polymers such as polydimethylsiloxane, and usually fit the molecular formula R₂SiO, with two methyl groups bonded to the silicon atom and one bridging oxygen group for each silicon. They are often functionalized with a polymerizable group at one or both ends. The small molecule pentamethyldisiloxanyl methylmethacrylate (I) is a simple form of a linear siloxane.

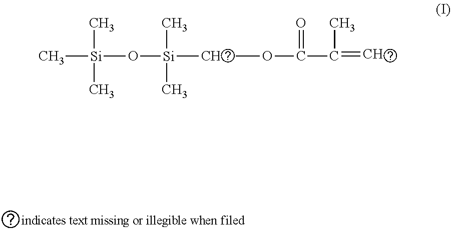

TRIS groups are branched siloxanes, where a central silicon atom is bonded to one organic group that can also contain a polymerizable group. The remaining three groups bonded to the central silicon are composed of silicon-oxygen bonds to other silicon atoms. The central atom of the TRIS structure has the formula RSiO_{1.5}. An early description of TRIS type molecules from U.S. Pat. No. 3,808,178 to Gaylord is structure (II)-3-methacryloyloxypropyl tris(trimethylsiloxy)silane.

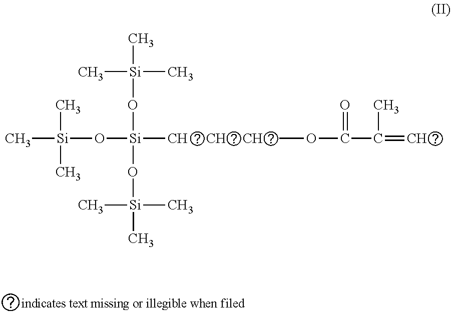

A third class of silicones useful in contact lenses is silicon-containing cage molecules, based upon the structure of oxygen and silicon tetrahedrons. The silicon atoms are substantially bonded to other silicon atoms through siloxane bonds, and one of the simplest structures formed from this is a cube, structure (III). These silsesquioxane molecules also fit the RSiO_{1.5} formula, but unlike the branched TRIS molecules, form 3 dimensional structures. These molecules take on the name POSS, which stands for Polyhedral Oligomeric Silsesquioxane. They have a silica type core and organic side groups that are covalently attached to the vertices of the inorganic polyhedron. They are commonly thought to bridge the gap between organic and inorganic materials. Through judicious choice of the chemistry one can obtain properties that exhibit the desired representation of each component.

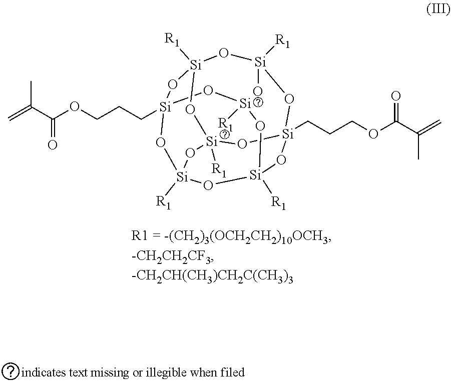

Highly functionalized POSS cages may be linked together through the monofunctional monomers during polymerization. The cages are essentially pre-polymers or macromers due to the combination of their high molecular weight (generally over 1000 amu) and high functionality. The functionality is locked into place during the polymerization and extends throughout the material. Phase separation is also minimized. As a result, hydrophilic polyethylene glycol (PEG) side groups may extend throughout the polymer matrix. This results in different properties than incorporating PEG functional groups using acrylate monomers, or simply adding PEG to the monomer mixture and then carrying out the polymerization.

In accordance with an aspect of the present invention, a POSS cage which includes at least two polymerizable groups becomes part of the polymer backbone with the polymer chains extending from each side of the cage. POSS molecules can be classified as telechelic monomers, which polymerize with themselves or with other monomers to incorporate the POSS cage into the polymer backbone. POSS monomers can be thought of as telechelic oligomers. A telechelic polymer is a di-end-functional polymer where both ends possess the same functionality. In this way the flexible polymerizable groups can be used to incorporate the cage-like silicone into the polymer backbone to create materials that are flexible and durable. As a result, POSS cages with two polymerizable groups allow for the design of contact lens materials that can be either soft or hard, and at the same time display high oxygen transport.

In accordance with another aspect of the present invention, exemplary POSS monomers have been employed that are bonded to two polymerizable groups and also have PEG groups bonded to the cage that make the POSS compatible with other silicones to form hydrogels. Without limitation to PEG groups, other hydrophilic monomers may also be employed to further enhance the material properties. It has been found that POSS cages that have two methacrylate groups and six PEG groups can be polymerized into rod-like materials that are optically clear. One non-limiting example of a POSS monomer is shown below as POSS I. These materials are suitable for lathing into buttons that can be used to make ophthalmic lenses, including contact lens for the eyes. Hydrophilic monomers including (hydroxyethyl)methacrylate (HEMA), N-vinylpyrrolidone (NVP), and dimethylacrylamide (DMAA) may also be used for these materials.

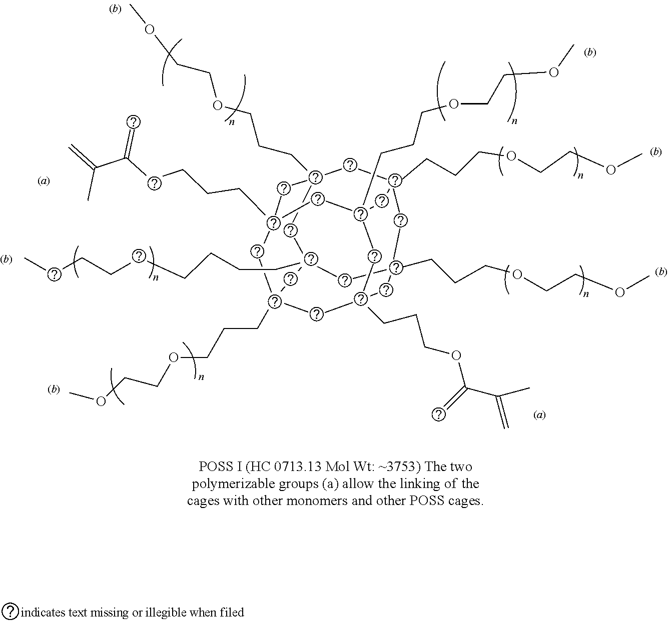

It has been further found that mixing the side groups (i.e., the six PEG groups (b) in POSS I) with different functional moieties may allow for the design of materials with greater varieties of properties. The judicious choice of the other side groups allows for the tailoring of other properties into the materials, such as hydrophilic character that is compatible with fluoroacrylates. Specifically, fluoroalkyl and alkyl side chains may be placed at the vertices of the telechelic POSS molecule, such as that shown below as POSS II. PEG side groups were also placed at two of the eight available vertices to maintain the hydrophilic character of the material.

The POSS II molecule was useful for copolymerization with the fluoroacrylate monomers when other monomers were also present. The combination of POSS II with fluoroacrylates resulted in clear polymeric materials that were suitable for fabrication into ophthalmic lenses using a lathe. It should be noted that POSS II results were in contrast to the POSS I materials results where POSS I was unable to prepare clear polymers with equal amount by weight with the fluoroacrylate. Rather, it was found that it was necessary to add a compatibilizer, such as a polar monomer, when POSS I was mixed with the fluoroacrylate. As a result, POSS II was found to be more compatible with the fluoroacrylate than was POSS I. Without being limited to any particular theory, the improved compatibility of POSS II may be due to the fluoroalkyl side groups (c) present on POSS II.

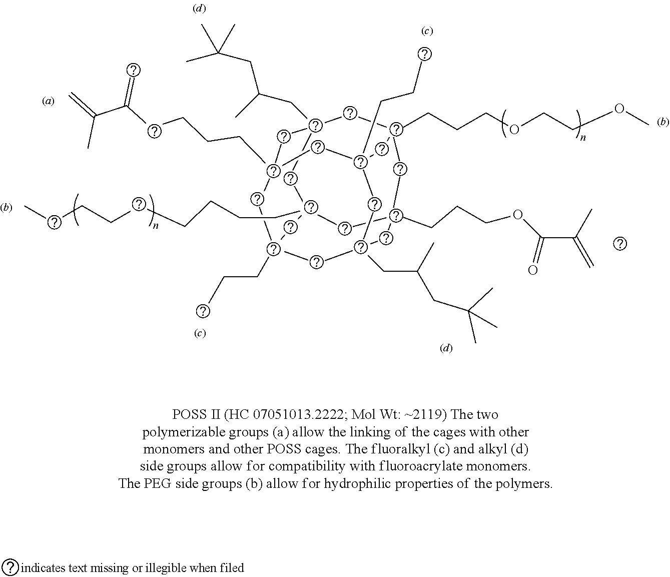

The combination of POSS II with the fluoroacrylates and other siloxanes produced materials with high oxygen transport, where the Dk values ranged from 100-200 units. The hydrophilic properties of the PEG substituents on the POSS produced materials that wet in saline solution, even though hydrophilic monomers such as (meth)acrylic acid were not present. This is an advantage because (meth)acrylic acid is generally added to contact lens formulations to enable wetting of the surfaces of the lens with tears in the eye. This can be detrimental to the patient's comfort as the (meth)acrylic is known to cause eye irritation.

It is significant that high Dk is achieved using POSS II without the addition of styryl tris, as in U.S. Pat. No. 10,633,472. Styryl tris is an expensive monomer that adds a great deal of cost to the material. Additionally, styryl tris raises the glass transition temperature (Tg) of the polymer, which can be a detriment when preparing materials that are soft and flexible. Also, styrenic materials tend to be very hydrophobic and prevent water absorption throughout the layer or coating of the material.

Alternatively, hydrophilic monomers such as DMAA, NVP, and PEG may be incorporated into the above ophthalmic formulations to produce clear polymers. These polymers may also be suitable for lens fabrication by lathing. Additionally, these polymer materials swell in water which resulted in a drop in the durometer of the hydrated buttons. For example, the Shore D hardness in the dry polymer rod made with POSS II (Example 4) is about 60, but drops to 17 after sitting in water at 35° C. for 72 hours. The discs cut on the lathe remained clear in saline, but became flexible and soft to the touch.

POSS cages with higher levels of acrylate may also be useful in accordance with further aspects of the present invention. By way of example, POSS cubes with three PEG side groups (b) and five acrylate moieties (a) may provide for hydrophilic materials with higher degrees of cross-linking. One non-limiting example of this class of siloxanes is shown as POSS III.

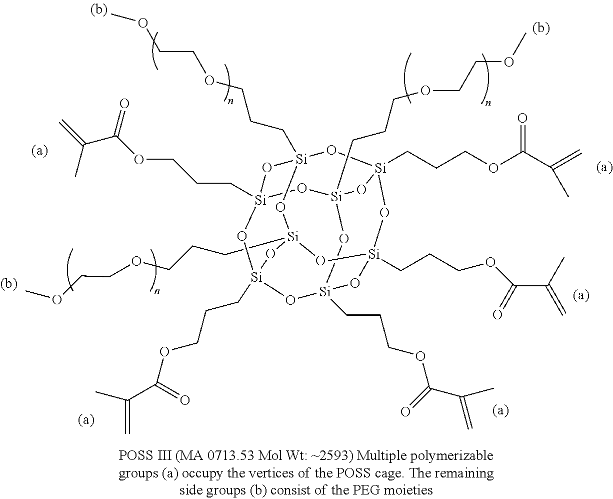

The structures shown for the PEG-POSS molecules are idealized representations of the actual structures for these molecules. The materials are mixtures of 8, 10, and 12 cage sizes. The functionality is randomly distributed around the cages. The drawings do not represent exact structures.

In accordance with a further aspect of the present invention, a method of producing an high Dk material comprises contacting and reacting: a multifuctional POSS macromer such as POSS II; a fluoroalkyl methacrylate; an alkyl glycol dimethacrylate; a hydrophilic agent, such as methacrylic acid; a methacryl functional tris(trimethylsiloxy)silane; a methacryl functional terminated polydimethylsiloxane; and styrylethyltris(trimethylsiloxy)silane. By way of example and without limitation thereto, the fluoroalkyl methacrylate may be hexafluoroisopropyl methacrylate; the alkyl glycol dimethacrylate may be neopentyl glycol dimethacrylate; the methacryl functional tris(trimethylsiloxy)silane may be 3-methacryloyloxypropyl tris(trimethylsiloxy)silane; and the methacryl functional terminated polydimethylsiloxane may be 4-methacryloxybutyl terminated polydimethylsiloxane.

The reaction is conducted within an inert atmosphere (e.g., nitrogen, argon or helium) at a pressure of at least 25 psi for a period of time and at a temperature sufficient to produce the ultra-high Dk material. As discussed above, the reaction may be conducted at room temperature, e.g., between about 20° C. and about 25° C., or at an elevated temperature, such as up to about 50° C., and under pressures between about 25 psi and about 1,000 psi. As a result, the ultra-high Dk material may have a Dk value greater than 175, with reactions conducted at higher pressures yielding materials with higher Dk values. The ultrahigh Dk materials produced in accordance with the present invention do not require surface treatments, such as plasma treatments, due to the incorporation of the hydrophilic PEG moieties that are built into the polymer matrix.

The polymerization reaction may be conducted within a vessel wherein the internal dimensions and geometry correspond to the desired size and shape or the ultra-high Dk material. That is, the ultra-high Dk material will polymerize within the vessel in the shape or the void or the vessel. The vessel may be constructed of a material, such as polypropylene or polytetrafluoroethylene (PTFE), that is permeable to the inert gas comprising the inert atmosphere. In accordance with an aspect or the invention, the vessel may reside with a thermostatically-controlled oven set at a specific temperature, or the oven may be programmable so as to permit reactions with variable temperature profiles. However, it is not a requirement that the polymerization be carried out under higher than normal atmospheric pressure.

### Advantages

Exemplary, non-limiting advantages of this invention may include:
a) the hydrophilic component PEG is incorporated throughout the polymer matrix;
b) wetting agents such as methacrylic acid are not required in the polymer matrix to achieve hydrophilic character;
c) the styryl tris is not a necessary component to achieve high oxygen transport (Dk). Styryl tris is an expensive monomer that raises Tg of a material and is generally a barrier to water absorption;
d) the material is transparent;
e) the dry material is hard enough to be formed into ophthalmic lenses on a lathe; and
f) the material can be soft and fashioned into a coating.

### EXAMPLES

Polymeric rods containing the POSS were fashioned into discs or buttons in three cases. The buttons were transparent to light and had good mechanical properties that were suitable to lathe cutting into lenses. The Example compositions are given below. Oxygen permeability was measured using a Dk Polarographic Cell and reported in Table 1, along with water absorption, hardness, and appearance.

### Example 1. Clear; Dk 198 (Uncorrected); Shore D 45; Water Absorption 1.2% (Wt)

| Component | Weight % | CAS Number |
|---|---|---|
| POSS II HC 07051013.2222 | 30 | NA |
| 3-Methacryloyloxypropyltris(tri- | 30 | 17096-07-0 |
| methylsiloxy)silane | | |
| Hexafluoroisopropyl methacrylate | 30 | 3063-94-3 |
| 4-methacryloxybutyl terminated | 10 | 58130-03-3 |
| poly(dimethylsiloxane) | | |
| Trigonox 141 | 0.4 | 13052-09-0 |

### Comparative Example 1. Clear; Shore D 75; Material does not Wet, Must be Plasma Treated for Wetting

| Component | Weight % | CAS Number |
|---|---|---|
| Hexafluoroisopropyl methacrylate | 44 | NA3063-94-3 |
| Neopentyl glycol dimethacrylate | 8 | 1985-51-9 |
| Methacrylic acid | 0 | 79-41-4 |
| 3-Methacryloyloxypropyltris(tri- | 21 | 17096-07-0 |
| methylsiloxy)silane | | |
| 4-methacryloxybutyl terminated | 11 | 58130-03-3 |
| poly(dimethylsiloxane) | | |
| Styryltris(trimethylsiloxy)silane | 16 | 18547-54-1 |
| Trigonox 141 | 0.07 | 13052-09-0 |

It should be noted that Comparative Example 1 is the same as ultra-high Dk formulation from U.S. Pat. No. 10,633,472 Table 1, but without methacrylic acid. Soaking in water overnight at 35° C. resulted in no water absorption. There was no change in weight, thickness, or diameter of a disk.

### Example 2. Translucent; Dk 139 (Uncorrected); Shore D 66; Material Wets but does not Absorb Water Overnight

| Component | Weight % | CAS Number |
|---|---|---|
| POSS II HC 07051013.2222 | 33.3 | NA |
| Styryltris(trimethylsiloxy)silane | 33.3 | 18547-54-1 |
| Hexafluoroisopropyl methacrylate | 33.4 | 3063-94-3 |
| Trigonox 141 | 0.4 | 13052-09-0 |

### Example 3. Clear; Dk 131 (Uncorrected); Shore D 60 Water Absorption 1.3% (Wt) after 1 Overnight; 1.9% (Wt) after 2 Overnights

| Component | Weight % | CAS Number |
|---|---|---|
| POSS II HC 07051013.2222 | 33.3 | NA |
| 3-Methacryloyloxypropyltris(tri- | 33.4 | 17096-07-0 |
| methylsiloxy)silane | | |
| Hexafluoroisopropyl methacrylate | 33.3 | 3063-94-3 |
| Trigonox 141 | 0.4 | 13052-09-0 |

### Example 4. Clear; Dk 58 (Uncorrected); Shore D 56; Water Absorption 20% (Wt)

| Component | Weight % | CAS Number |
|---|---|---|
| POSS II HC 07051013.2222 | 24 | NA |
| 3-Methacryloyloxypropyltris(tri- | 24 | 17096-07-0 |
| methylsiloxy)silane | | |
| Hexafluoroisopropyl methacrylate | 12 | 3063-94-3 |
| 4-methacryloxybutyl terminated | 9 | 58130-03-3 |
| poly(dimethylsiloxane | | |
| Dimethylacrylamide | 30 | 2680-03-7 |
| Trigonox 141 | 0.4 | 13052-09-0 |

### Example 5. Clear; Shore D 37; Water Absorption 40% (Wt)

| Component | Weight % | CAS Number |
|---|---|---|
| POSS I HC 0713.13 | 33.3 | NA |
| Hexafluoroisopropyl methacrylate | 33.3 | 3063-94-3 |
| 2-Hydroxyethyl methacrylate | 33.3 | 868-77-9 |
| Trigonox 141 | 0.4 | 13052-09-0 |

### Example 6. Clear; Shore D 65; No Water Absorption, Possibly Due to High Crosslinking Levels

| Component | Weight % | CAS Number |
|---|---|---|
| POSS III MA 0713.53 | 50 | NA |
| Hexafluoroisopropyl methacrylate | 42 | 3063-94-3 |
| Neopentylglycol dimethacrylate | 8 | 868-77-9 |
| Trigonox 141 | 0.4 | 13052-09-0 |

TABLE 1
Summary of Results from Comparative
Example 1 and Examples 1-6.

| | Dk | Hardness | Water absorption | |
|---|---|---|---|---|
| Example | (uncorrected) | (Shore D) | (wt %) | Appearance |
| 1 | 198 | 45 | 1.2 | Clear |
| Compar- | Did not wet | 75 | 0 | Clear |
| ative 1 | | | | |
| 2 | 139 | 66 | 0 | Translucent |
| 3 | 131 | 60 | 1.3 (1 overnight) | Clear |
| | | | 1.9 (2 overnight) | |
| 4 | 58 | 56 | 20 | Clear |
| 5 | NA | 37 | 40 | Clear |
| 6 | NA | 65 | 0 | Clear |

The above examples show that PEG substituents on the POSS silicon cage provide the necessary wetting characteristics required for water absorption. The Examples are free of methacrylic acid which is commonly used as a surface treatment to provide some hydrophilic character in the high Dk materials (Dk>100). Comparative Example 1, made without methacrylic acid, does not wet in water. It was necessary to plasma treat the surface of Comparative Example 1 to provide wetting in a saline solution. By contrast, Example 1 was found to have a high Dk of approximately 200 without post treatment of the disc surface.

Although the invention has been described with reference to preferred embodiments thereof, it is understood that various modifications may be made thereto without departing from the full spirit and scope of the invention as defined by the claims which follow.

What is claimed is:

1. A silicone cage suitable for producing a transparent, hydrophilic, flexible polymeric material with high oxygen permeability (Dk>100), the silicone cage comprising at least two polymerizable groups and at least two hydrophilic side chains covalently bonded thereto.

2. The silicone cage in accordance with claim 1 further comprising one or more acrylic monomers or acrylate functionalized polymers covalently bonded to the silicone cage.

3. The polymeric material in accordance with claim 1 wherein the silicone cage comprises a polyhedral oligomeric silsesquioxane (POSS) cage having a T8, T10 or T12 cage size.

4. The silicone cage in accordance with claim 3 wherein the two polymerizable groups comprise acrylic functional groups and the two hydrophilic side chains comprise polyethylene glycol (PEG) groups.

5. The silicone cage in accordance with claim 4 wherein the acrylic functional groups comprise propyl methacrylate and the PEG groups have an oxyethylene repeating unit of between 2 and 20.

6. The silicone cage in accordance with claim 5 wherein the acrylic functional groups further comprises a hydrophilic monomers selected from 2-hydroxyethylacrylate, N-vinyl pyrrolidone, and dimethylacrylamide.

7. The silicone cage in accordance with claim 4 wherein the silicone cage further comprises two fluoroalkyl groups and two hydrocarbon chain groups.

8. The silicone cage in accordance with claim 7 wherein the fluoroalkyl groups are trifluoropropyl groups and the hydrocarbon chain groups comprise branched C-8 alkanes.

9. A transparent, hydrophilic, flexible polymeric material comprising:
a) the silicone cage from claim 8 at about 30 wt %;
b) 3-(methacryloyloxy)propyl tris(trimethylsiloxy) silane at about 30 wt %;
c) 1,1,1,3,3,3-hexafluoroisopropyl methacrylate at about 30 wt %; and
d) 4-methacryloxybutyl terminated polydimethylsiloxane at about 10 wt %.

10. The polymeric material in claim 9 formed into ophthalmic lenses which are wettable and have a Dk greater than 100.

11. The silicon cage in accordance with claim 4 wherein the silicon cage comprises two polymerizable acrylic functional groups and six PEG groups.

12. A transparent, hydrophilic, flexible polymeric material comprising:
a) the silicone cage from claim 11 at about 33 wt %;
b) 1,1,1,3,3,3-hexafluoroisopropyl methacrylate at about 33 wt %; and
c) 2-hydroxyethyl methacrylate at about 33 wt %.

13. The polymeric material in accordance with claim 12 formed into ophthalmic lenses which are highly wettable.

14. The silicone cage in accordance with claim 4 wherein the silicone cage comprises five acrylic functional groups and three PEG group.

15. A transparent, hydrophilic, flexible polymeric material comprising:
a) the silicone cage from claim 14 at about 50 wt %;
b) 1,1,1,3,3,3-hexafluoroisopropyl methacrylate at about 42 wt %; and
c) neopentyl glycol dimethacrylate at about 8 wt %.

16. The polymeric material in accordance with claim 15 formed into ophthalmic lenses which are highly wettable.
